(19) United States
(12) Patent Application Publication
(10) Pub. No.: US 2016/0019620 A1
(43) Pub. Date: Jan. 21, 2016

(54) DYNAMIC IMAGE SITELINKS

(71) Applicant: GOOGLE INC., Mountain View, CA (US)

(72) Inventors: Shipra Bajpai, Gurgaon (IN); Sheeba Areeb Fatima, Gurgaon (IN)

(21) Appl. No.: 14/500,060

(22) Filed: Sep. 29, 2014

(30) Foreign Application Priority Data
Jul. 15, 2014 (IN) 3485/CHE/2014

(51) Int. Cl. G06Q 30/06; G06F 17/30

(52) U.S. Cl. CPC G06Q 30/0625; G06F 17/30864; G06F 17/30277

(57) ABSTRACT

Systems and methods for determining and providing dynamic content item images are provided. A data processing system can determine a content item including an image. The content item is provided for display on a device. Upon receiving an indication of interest in the image, a plurality of additional images is determined based on historical activity information associated with the device. The additional images are provided for display by the device, in place of the image. Data associated with each image includes a URL of a web page associated with a product depicted in an image. The web page enables the user to purchase the product depicted in the image.

### CROSS-REFERENCE TO RELATED PATENT APPLICATIONS

This application claims priority to and the benefit of India Application No. 3485/CHE/2014, entitled “Dynamic Image Sitelinks.” filed Jul. 15, 2014, and which is incorporated herein by reference in its entirety for all purposes.

### BACKGROUND

Online content may be explored by browsing of various websites or viewing content provided by mobile applications executing on computing devices. The online content can include content items paid by content providers, who would like to attract users to their online properties. Content items provide limited information regarding a small number of products offered by content providers. In order to explore more products offered by a content provider, the user currently needs to visit the content provider's online property (e.g., website, mobile application).

### SUMMARY

At least one aspect is directed to a method. The method includes determining a content item including an image. The method further includes providing the content item for display on a device. The method further includes receiving an indication of interest in the image. The method further includes determining a plurality of additional images based on historical activity information associated with the device. The method further includes providing the plurality of additional images for display by the device, in place of the image. Data associated with each image includes a URL of a web page associated with a product depicted in an image, the web page enabling the user to purchase the product depicted in the image.

At least one aspect is directed to a system. The system includes: one or more data processors; and one or more storage devices storing instructions that, when executed by the one or more data processors, cause the one or more data processors to perform operations comprising: determining a content item including an image; providing the content item for display on a device; receiving an indication of interest in the image; determining a plurality of additional images based on historical activity information associated with the device; and providing the plurality of additional images for display by the device, in place of the image, wherein data associated with each image includes a URL of a web page associated with a product depicted in an image, the web page enabling the user to purchase the product depicted in the image.

At least one aspect is directed to a computer-readable storage medium having instructions to provide information via a computer network. The instructions comprising instructions to: determine a content item including an image; provide the content item for display on a device; receive an indication of interest in the image; determine a plurality of additional images based on historical activity information associated with the device; and provide the plurality of additional images for display by the device, in place of the image, wherein data associated with each image includes a URL of a web page associated with a product depicted in an image, the web page enabling the user to purchase the product depicted in the image.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of a computer system, in an accordance with a described implementation;

FIG. 2 is an illustration of a webpage displaying content items having dynamically determined images, in an accordance with a described implementation;

FIGS. 3A-H illustrate individual states of an content item presenting dynamically selected images, in an accordance with a described implementation;

FIG. 4 is an illustration of a webpage enabling a user to purchase a product shown in the image selected by the user in FIG. 3H, in an accordance with a described implementation;

FIG. 5 is an illustration of an online content item including multiple dynamic images, in accordance with a described implementation;

FIG. 6 is a flow diagram of a process for determining and providing a content item; and

FIG. 7 is a flow diagram depicting one implementation of a process for determining and providing a content item.

Like reference numbers and designations in the various drawings indicate like elements.

### DETAILED DESCRIPTION

Numerous specific details may be set forth below to provide a thorough understanding of concepts underlying the described implementations. It may be apparent, however, to one skilled in the art that the described implementations may be practiced without some or all of these specific details. In other instances, some process steps have not been described in detail in order to avoid unnecessarily obscuring the underlying concept.

According to various implementations disclosed herein, content items may be presented on a screen of a computing device. The content items can include any combination of text, site links, and images. Search results for a product, performed by a search engine, may be presented together with content items. Alternatively, a portion of a displayed webpage may include content items. In yet another implementation, a mobile device application may display content items along with the output of the mobile application.

A content item may include one or more images that change upon detection of interest. Interest may be inferred by detecting that a user interface cursor remains placed over the image for a period of time. When interest is detected in an image shown in the content item, that image may changes to another image selected from a set of dynamically determined images. Each image shown in the content item may have a set of additional images associated with it that are displayed upon a detection of interest.

As an illustration of this, a content item may initially display three images (or any other number of images) and a text section. Upon detection that a user interface cursor has remained placed over one of the three images for a period of time, four additional images (or any other number of additional images) may be shown in place of that image, one image at a time. The additional images may be changed intermittently (e.g., every five seconds or any other period of time). Upon detection that the cursor is no longer placed over the image, the images stop changing. If the cursor is placed over another of the three images, four additional images (which may be different from the four additional images used for the first image) are shown in place of another of the three images, one image at a time, on an intermittent basis.

The initially shown images or the additional images may be determined based on device information. The device information can include cookie information associated with the computing device. Other information can be utilized in combination with the device information to dynamically determine images for display including content provider information including data selected by a content provider (e.g., hot selling product lists, content provider selected images, or other information). Weights may be applied to weigh the device information and the content provider information in order to determine the images to display. The weights may be pre-determined or dynamically generated.

In some implementations, content providers can indicate (e.g., using one or more user interfaces) how the content service 122 needs to select images for display in content items associated with the content providers. A content provider may be allowed to indicate (e.g., using a user interface) that images of products identified by the content provider are to be included in content items associated with the content provider. The products identified by the content provider may be hot selling products. The content provider may be allowed to indicate that they prefer the content service 122 (or another system or service) to use the cache and/or cookies to dynamically select images for content items. In these implementations, either of the two arrangements would be used by the content service 122 to select the images for display in content items.

The one of the displayed images (e.g., one of the initially shown images or one of the additionally shown images) may be selected (e.g., by receiving a click). When an image shown in the content item is selected (e.g., clicked on), the web browser of the computing device may be directed to a webpage allowing for selection of product quantity and other attributes if applicable (e.g., size, color), and initiation of order placement of a product depicted in the selected image.

In some implementations, the content items may be advertisements that include any combination of text, site links, and dynamically determined images. For example, a content item may display text, three site links, and four images displaying products in different categories. In this example, the first image may show a shoes product, while the second image may show an apparel product, the third image may show a home product, and a fourth image may show an accessory product. When an indication of interest for the first image in the advertisement showing shoes is received, other additional images of shoes are shown. In particular, while the cursor is placed over the first image, the first image changes to a first image from a set of additional images, and then that image changes to another image from the set of additional images, etc. For example, a total of five images may be in the set of additional images associated with the first image in the advertisement. As a result, multiple images of other products offered by the content provider can be displayed.

Next, the cursor may be placed over another image shown in the content item, and in turn other additional images may be shown, one image at a time. Each of the four images shown in the content item may have a set of dynamically determined additional images associated with them. For example, if five images are associated with each of the four images shown in the content item, a total of twenty images can be viewed. When any of these images are selected (e.g., clicked on), a billing page associated with a product or service depicted in the selected image is presented.

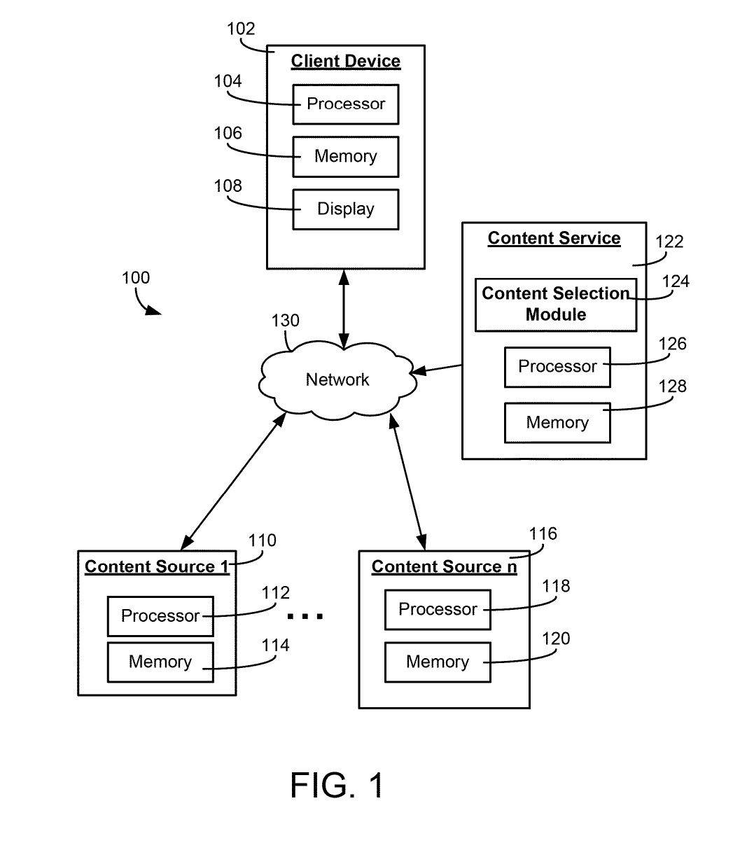

Referring to FIG. 1, a block diagram of a computer system 100 in accordance with a described implementation is shown. The system 100 includes a client device 102, which communicates with other computing devices via a network 130. The client device 102 may execute a web browser or another application (e.g., a video game, a messenger program, a media player, a social networking application, a navigation program, etc.) to retrieve content over the network 130. For example, the client device 102 may communicate with any number of content sources 110-116 (e.g., a first content source through nth content source).

The client device 102 may be any number of different types of user electronic devices configured to communicate via the network 130 (e.g., a laptop computer, a desktop computer, a tablet computer, a smartphone, a digital video recorder, a set-top box for a television, a video game console, combinations thereof, etc.). The client device 102 is shown to include a processor 112 and a memory 114, i.e., a processing circuit. The memory 114 may store machine instructions that, when executed by the processor 112 cause the processor 112 to perform one or more of the operations described herein. The processor 112 may include a microprocessor, ASIC, FPGA, etc., or combinations thereof. The memory 114 may include, but is not limited to, electronic, optical, magnetic, or any other storage or transmission device capable of providing the processor 112 with program instructions. The memory 114 may include a floppy disk, CD-ROM, DVD, magnetic disk, memory chip, ROM, RAM, EEPROM, EPROM, flash memory, optical media, or any other suitable memory from which the processor 112 can read instructions. The instructions may include code from any suitable computer programming language such as, but not limited to, C, C++, C#, Java, JavaScript, Perl, HTML, XML, Python and Visual Basic.

The client device 102 may include one or more user interface devices. A user interface device may be any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to the housing of client device 102 (e.g., a built-in display, microphone, etc.) or external to the housing of the client device 102 (e.g., a monitor connected to client device 102, a speaker connected to client device 102, etc.), according to various implementations.

For example, the client device 102 may include an electronic display 108, which displays webpages and other data received from the content sources 110-116 and/or the content service 122. In various implementations, the display 108 may be located inside or outside of the same housing as that of the processor 104 and/or the memory 106. For example, the display 108 may be an external display, such as a computer monitor, television set, or any other stand-alone form of electronic display. In other examples, the display 108 may be integrated into the housing of a laptop computer, a mobile device, or other form of a computing device having an integrated display.

The computer system 100 may include a content service 122 configured to determine content to be provided to the client device 102 for display to the user. The content may be provided to the content service 122 by content providers. For example, content provider scan be advertisers, who create advertisements (using the content service or another service coupled to or in communication with the content service), which can be selected and served by the content service 122 to client devices.

Similar to the content sources 110-116, the content service 122 may be one or more electronic devices connected to the network 130. The content service 122 may be a computer server (e.g., FTP servers, file sharing servers, web servers, etc.) or a combination of servers (e.g., a data center, a cloud computing platform, etc.). The content service 122 may have a processing circuit including a processor 126 and a memory 128 that stores program instructions executable by the processor 126. In cases in which the content service 122 is a combination of computing devices, the processor 126 may represent the collective processors of the devices, and the memory 128 may represent the collective memories of the devices.

The content service 122 includes a content selection module 124, which determines content for display on the client devices. When users visit various websites, information regarding their activities on those websites may be transmitted to the content service 122 or another service. The content selection module 124 may determine content items based on any combination of information provided by the content providers, contextual user behavior indicators, and/or the collected user behavior data. The content items may include dynamically determined images, which change upon detection of interest.

To protect privacy of participants, data collection may be limited or anonymized in many implementations. In particular, certain data may be anonymized in one or more ways before it is stored or used, so that personally identifiable information is removed. For example, a user's or client device's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by content selection service or another service. The user may be provided with an option for opting out of collection of any user behavior data.

The network 130 may be any form of computer network that relays information between the client device 102, the content sources 110-116, and the content service 122. For example, the network 130 may include the Internet and/or other types of data networks, such as a local area network (LAN), a wide area network (WAN), a cellular network, satellite network, or other types of data networks. The network 130 may also include any number of computing devices (e.g., computer, servers, routers, network switches, etc.) that are configured to receive and/or transmit data within the network 130. The network 130 may further include any number of hardwired and/or wireless connections. For example, the client device 102 may communicate wirelessly (e.g., via WiFi, cellular, radio, etc.) with a transceiver that is hardwired (e.g., via a fiber optic cable, a CAT5 cable, etc.) to other computing devices in the network 130.

The content sources 110 through 116 may provide webpage data and/or other content, such as images, video, audio, or an application to the client device 102. The content sources may be merchant websites providing product and other information. The content sources 116, 110 may be one or more electronic devices connected to the network 130 that provide content to devices connected to the network 130. For example, the content sources 110-116 may be computer servers (e.g., FTP servers, file sharing servers, web servers, etc.) or combinations of servers (e.g., data centers, cloud computing platforms, etc.). The content may include, but is not limited to, webpage data, a text file, a spreadsheet, images, search results, and other forms of electronic documents. Similar to the client device 102, the content sources 110, 116 may include processing circuits comprising processors 112, 118 and memories 114, 120, respectively that store program instructions executable by the processors 112, 118. For example, the processing circuit of the content source 116 may include instructions such as web server software, FTP serving software, and other types of software that cause the content source 116 to provide content via the network 130.

The client device 102 may identify itself to the content service 122 through the use of one or more device identifiers. Device identifiers may include, but are not limited to, cookies, UDIDs, device serial numbers, telephone numbers, or network addresses.

The content sources 110-116 may provide webpage data to the client device 102. The webpage data may include product information. For example, a website provided by the content source 116 may be a blog. In this example, the website may include links to merchant's products, and upon clicking on one of those links, the client device may be directed to a merchant's website (e.g., provided by the content source 110). Various products may be displayed on a single webpage.

In another example, a search may be conducted for products or other information on an Internet search engine. One of the links displayed in the search results may, when selected, direct the client device to a merchant's website. In another example, the URL address for a merchant's website may be typed directly into the address field provided by an Internet browser executing on client device 102 causing the browser to retrieve and display the identified page of the merchant's website.

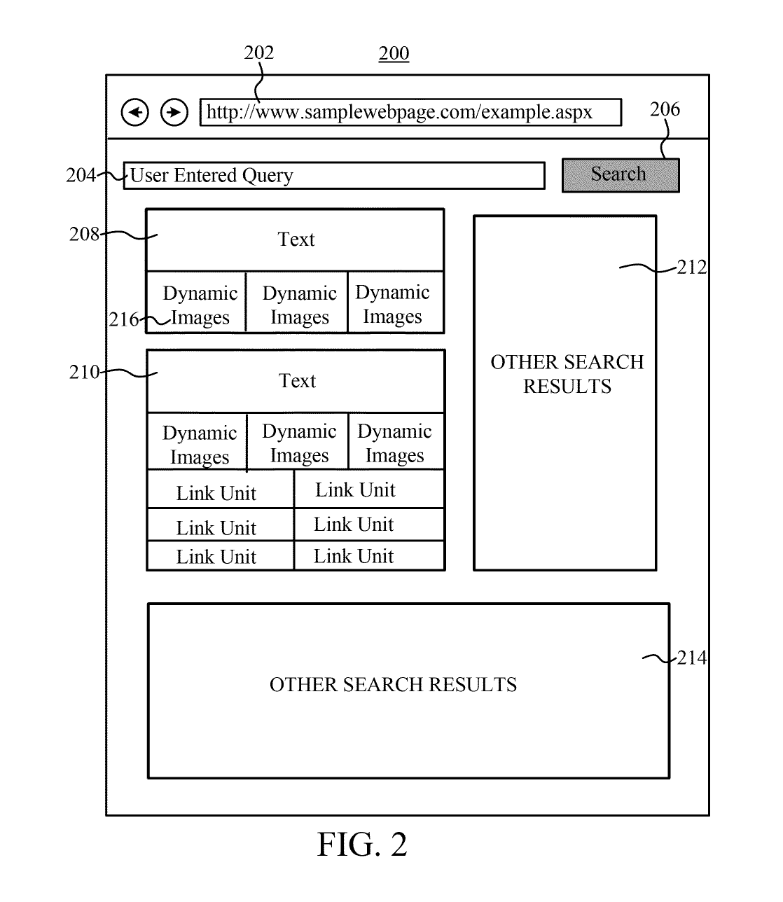

FIG. 2 illustrates an exemplary webpage 200 displaying on a client device search results including content items 208 and 210. A search query can be entered into a text box 204. The search query can include one or more words (e.g., “designer shoes”) that are of interest to the user. Upon selection of the search button 206, the webpage 200 displays content items 208 and 210 along with other search results 212 and 214. The content items 208 and 210 may be determined and provided by the content service 122 (or another service).

As shown, the content item 208 includes a text portion and three images. The three image slots can show dynamically determined images. In one implementation, the three image slots show three initial images. Then, upon detection of interest in one of those images, that image changes to another set of images, one image at a time. For example, the image slot 216 displays an image of a pair of shoes. Upon the cursor being placed over that image, the image of the pair of shoes changes to another image from the set of additional images, which in turn changes to another image form the set of additional images, etc. As a result, a larger number of products are shown in the content item.

As shown in FIG. 2, the content item 210 includes a text portion, slots for three dynamic images, and six link units, but an arbitrary number of text portions, dynamic images and link units may be provided. The content item 210 may be associated with a different content provider from the content provider associated with the content item 208. Similar to the content item 208, the images in the content item 210 dynamically change to other images upon detection of interest. In some implementations, only the content item at the first position (i.e., the content item 208) may include images. In these implementations, the content items at the positions below the first position would not include any images, but would instead include any combination of text and link units. In these implementations, the content item 210 would not include any of the dynamic images.

In one implementation, the three image slots shown in the content item 210 may display images of products from three separate product categories. In other implementations, the image slots can show images from overlapping product categories, but having other product distinctions (e.g., color, season, etc.).

Other search results 212 and 214 may include any number of content items that include any combination of text, images, link units, animation, videos, etc. The webpage 200 may include content items for which the respective content providers pay upon the selection (e.g., clicking) of those content items.

In another example, the content items 208 and 210 may be displayed in a web page associated with a content provider. The web page may display first party content (i.e., content generated by the content provider) along with the content items 208 and 210 determined and provided by the content service 122.

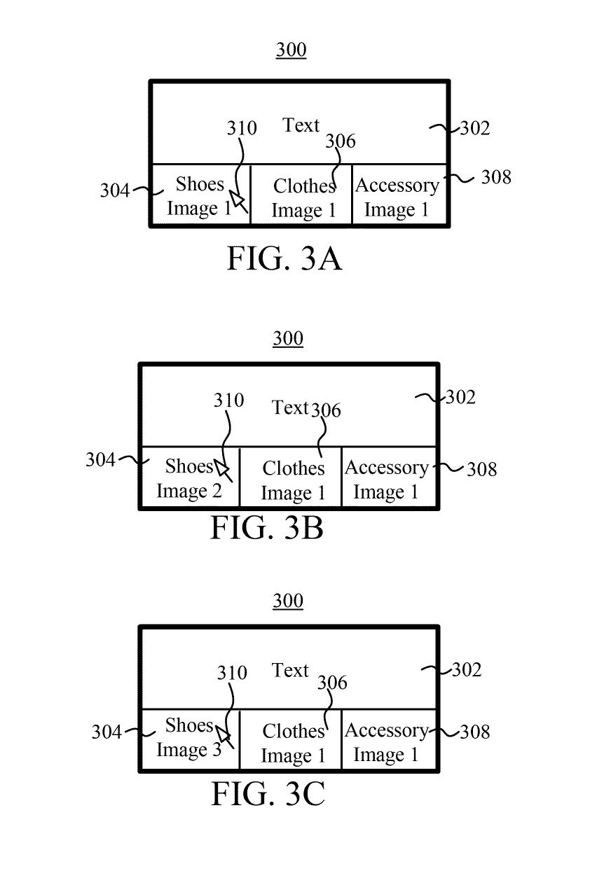

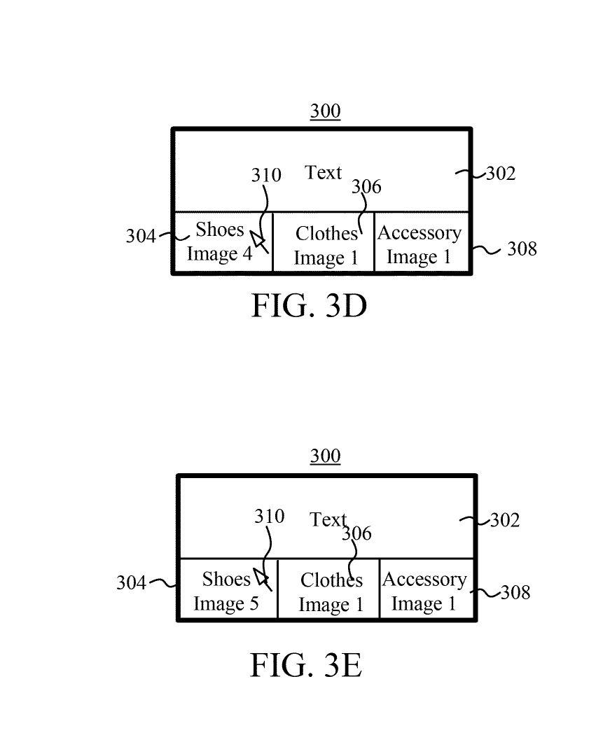

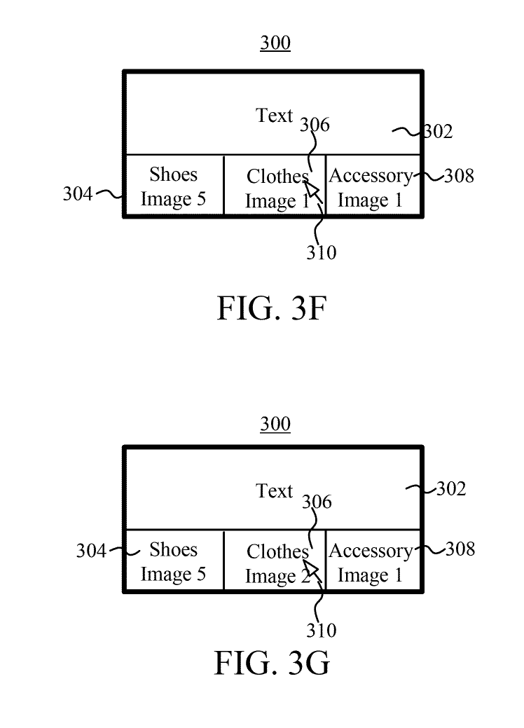

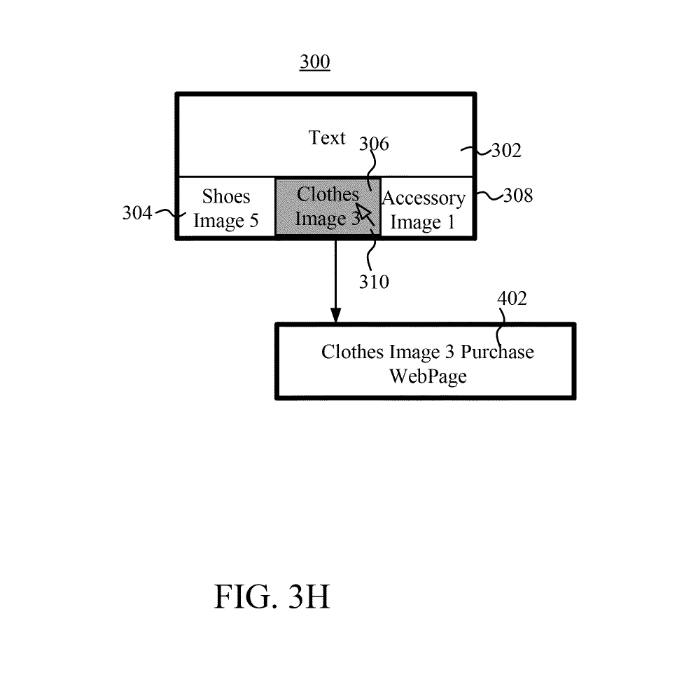

FIGS. 3A-H illustrate a content item 300 including a text portion 302 and image slots 304, 306, and 308. As shown in FIG. 3A, the image slot 304 displays a shoes image 1, while the image slot 306 displays a clothes image 1, and the image slot 308 displays an accessory image 1. The interest may be expressed in the shoes image 1 by having the cursor placed 310 over that image. As a result, the image shown in the image slot 304 changes to other images, one image at a time. In particular, the shoes image 1 shown in FIG. 3A changes to a shoes image 2 displayed in the image slot 304, as shown in FIG. 3B.

As the cursor 310 continues to be placed over the image slot 304, the shoes image 2 shown in FIG. 3B changes to a shoes image 3 as illustrated in FIG. 3C, which then it turn changes to a shoes image 4 as shown in FIG. 3D. The shoes image 4 (shown in FIG. 3D) changes to a shoes image 5 as shown in FIG. 3E. Thus, as a result of hovering cursor 310 over the first image slot 304, five images (i.e., shoes image 1, shoes image 2, shoes image 3, shoes image 4, and shoes image 5) are displayed. If the cursor 310 continues to be placed over the image slot 304, the images rotate from the beginning on an intermittent basis. The shoes image 5 would change back to the shoes image 1, which in turn would change to the shoes image 2, etc. In this manner, the five images can be viewed on the client device multiple times.

FIGS. 3F-G illustrate the placing of the cursor 310 over the image slot 306 after the image shown in the image slot 304 changes to the shoes image 5. In response to detecting interest in the image slot 306, the clothes image 1 shown in the image slot 306 changes to a clothes image 2 as shown in FIG. 3G. The shoes image 5 remains in the image slot 304, and the accessory image 1 remains in the image slot 308.

Detection that there is still interest in viewing more images in the image slot 306 (e.g., by identifying that the computing device cursor 310 remains over the image slot 306) results in clothes image 2 changing to a clothes image 3, as illustrated in FIGS. 3G-H. During display of the clothes image 3, this image may be selected (e.g., clicked on). Although the image selection is visually indicated by changing the background color of the image slot 306 to a darker shade, any other visualization technique may be utilized to emphasize the image selection. In another implementation, when an image is selected, the corresponding image slot is not visually updated or emphasized.

Once the clothes image 3 is selected, the web browser redirects the website displaying the content item to a web page 402, which allows for purchasing the product displayed in the clothes image 3. In particular, a billing or purchase webpage may be displayed that shows more information about the product associated with the clothes image 3 and allows for selection of necessary parameters to place an order for that product.

Each of the images shown (or available for display) in the content item 300 may include information that identifies the URL for the product or service associated with the image. Thus, the shoes image 1 may have a first URL associated with it, while the clothes image 1 may have a second URL associated with it, such that the first URL and the second URL are different URLs. The URLs associated with images in the content item may correspond to websites owned or controlled by a single content provider.

If the cursor continues to be placed over the image slot 306, additional images may be provided for display on the client device (e.g., clothes image 4 and 5). If the cursor continues to be placed over the image slot 306, the images may rotate from the beginning on an intermittent basis. Thus, the clothes image 5 would change back to the clothes image 1, which in turn would change to the clothes image 2, etc. In this manner, the five images of clothes products can be displayed on the client device multiple times.

Although not shown in FIGS. 3A-3H, any number of additional images can be displayed on the client device upon detection of interest in the accessory image 1 displayed in the image slot 308. In one example, four additional images may be dynamically determined for each image slot (including the image slot 308). Upon detection of the cursor 310 being placed over an image slot (e.g., the image slot 30), four determined additional images are displayed, one image at a time. In this example, a total of five images may be displayed in each image slot 304, 306, and 308. As a result, a total of fifteen images of products that may be of interest are displayed in a single content item.

Although five images can be shown in each of the image slots in the FIGS. 3A-3H, any other number of images can be shown in each individual image slot in FIGS. 3A-H. For example, the image slots 304, 306, and 308 can each show ten images, thus allowing for display of a total of thirty images. In another example, each image slot can show a different number of images. In this example, the image slot 304 can show a total of six images, while the image slot 306 can show a total of three images, and the image slot 308 can show five images.

Although only three images slots are shown in FIGS. 3A-3H, any other number of image slots can be included in a content item. For example, a content item can have a single image slot and show one image, which then changes to other additional images upon detection of interest in that image. In another example, a content item may have five images, with each image slot being configured to show the same number of images (e.g., five images per each image slot, three images per each image slot, etc.). In another example, a content item may have two image slots, with each image slot having four images that can be shown one a time upon detection of interest.

In some implementations, any content item can have a set maximum of image slots, and a set maximum of the number of images running in each image slot, thereby maintaining the quality and relevance of images. For example, any content item can have a maximum of four image slots, with a maximum of five images running in each image slot. That is a total of twenty images that can be displayed in a content item by a content provider. The maximum number of slots and images in each slot may be set due to limited space available in a content item. In some implementations, the content item including images may be placed in a first position on a webpage or an application, which may have limited space.

In one implementation, the number of image slots shown in a content item may dynamically change (e.g., increase, or decrease) as interest is detected. In another implementation, when interest is detected in a content slot displaying images related to a first product category, a second content slot, that displays images related to a second product category, may be updated to display images of the first product category.

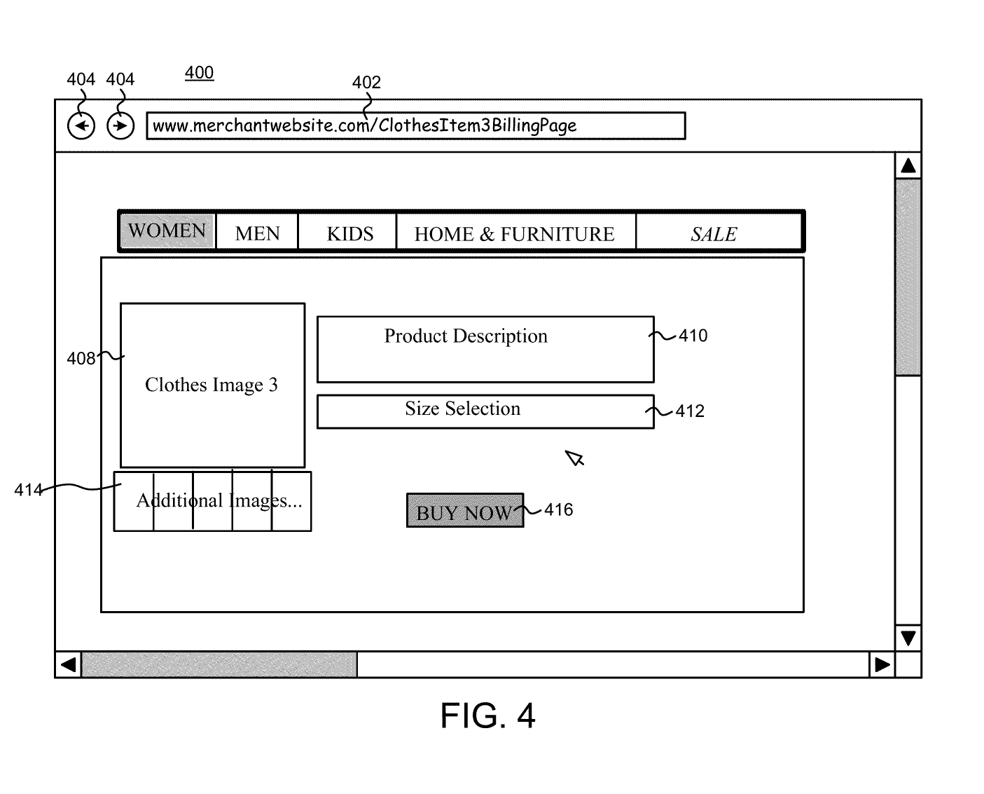

FIG. 4 displays the webpage 402 to which the client device web browser is directed after an image in the content item 300 is selected. As shown in FIG. 4, a user interface 400 displays the webpage 402 that is associated with the content provider of the content item 300. The webpage 402 displays product information for the product depicted in the clothes image 3 in FIG. 3H. As shown, an image slot 408 displays the clothes image 4. In other implementations, the image slot 408 can display another image of the product depicted in the clothes image 3.

As shown in FIG. 4, webpage 402 may display a product description 410. The webpage may also provide additional images 414 of the product (or service). Other information and content associated with the product may be displayed including, but not limited to, videos of the product, animation, information regarding related product(s), etc. Product size may be selected using the size selection controls 412 (or another control). Other product attributes (e.g., color, quantity) may be selected. Finally, once product attributes are selected, purchasing the product may be initiated using the webpage 402. Specifically, as shown in FIG. 4, a button 416 may be provided for placing an order of the product.

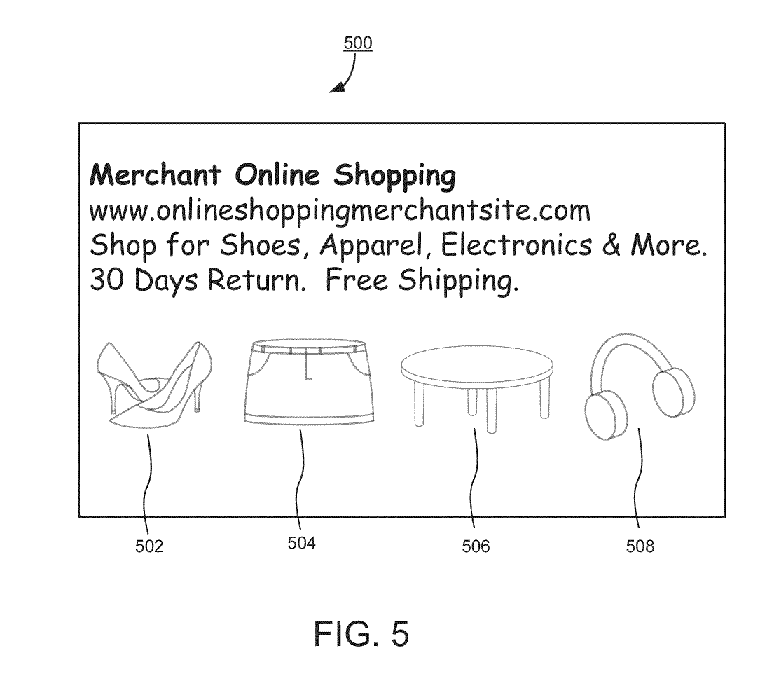

FIG. 5 depicts a content item 500 having a text portion and four images 502, 504, 506, and 508. Although each of the shown images is in a different product category, the images shown in a content item can be of any product category and several images in the same content item can be of the same product category. As shown in FIG. 5, the first image 502 is an image of shoes, and is in the shoes product category, while the second image 504 is an image of a skirt, which is in the clothes product category. The third image 506 is an image of a table, which is in furniture product category. Finally, the last image 508 is an image of a headset, which is in an electronics product category.

Each of the shown images 502, 504, 506, and 508 may have a set of additional images. In some implementations, each set of additional images may relate to a separate product category (e.g., shoes product category, clothes product category, etc.). In other implementations, each set of additional images may include images related to more than one product category.

Upon detection of interest in an image, that image may change to the associated set of additional images, one image at a time. For example, the image 502 may change to other images of shoes when the cursor is placed over that image slot. Upon selection of one of the images shown in the content item 500, a webpage is then displayed that allows for purchasing of the product depicted in the selected image.

Although four images are shown in FIG. 5, the content item 500 can include any number of image slots (e.g., three image slots). In turn, each image slot may display any number of additional images upon detection of interest in the initially shown image. In some implementations, a content item can have a predetermined maximum number of image slots (e.g., a maximum of four image slots), and each image slot may have a predetermined maximum of images (e.g., a maximum of five images in each image slot). The four different image slots shows in the content item 500 may show images of products in same or different product categories.

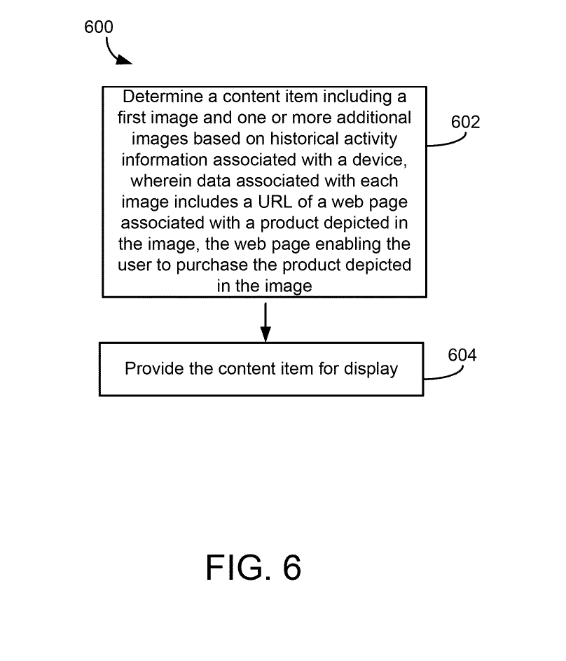

FIG. 6 is a flow diagram of a process 600 for determining a content item with dynamically selected images, in accordance with an illustrative implementation. The process 600 can be implemented on a computing device (e.g., a server). In one implementation, the process 600 is encoded on a computer-readable medium that contains instructions that, when executed by the computing device, cause the computing device to perform operations of the process 600.

At block 602, a content item is determined including a first image and one or more additional images based at least in part on historical activity associated with a device. The content item including the first image may be initially displayed on the computing device. Upon detection of interest in the first image, the additional images may be displayed in place of the first image, one image at a time.

Data associated with the first image and each image in the one or more additional images includes a URL of a web page associated with a product depicted in the respective image. When the first image is selected, the URL associated with the first image is used to redirect the web browser of the device to a web page having that URL that enables the user to purchase the product depicted in the first image. Similarly, when one of the additional images is selected, the URL associated with that image is used to redirect the web browser of the device to a web page having that URL that enables the user to purchase the product depicted in that image.

Any number of images (e.g., four images as shown in FIG. 5) may be initially shown in the content item, and each of the initially shown images can have any number of additional images associated with them. For example, four images may be determined for the content item and displayed on the computing device. In this example, each of these four images may have an additional set of images. Each set of additional images may have any number of images associated with them (e.g., three images in each set of additional images).

To determine the images, including the initial image(s) and the additional set(s) of images, historical activity (of the client device) can be utilized. The historical activity information can include cookie information, past actions, past actions on the device, etc. Other type of information associated with the content device may be utilized to determine the images such as user demographic information, interests, etc. In some implementations, device information may be utilized in combination with information provided by or selected by a content provider associated with the content item.

The information provided by the content provider may include hot selling product list(s), important product categories, top images, and/or other information. In other implementations, information regarding interactions with images shown in content items displayed on other computing devices may be utilized to determine the initial images and the sets of additional images. For example, images that have received the most interest (e.g., cursor being placed over those images, clicking on those images, etc.) may be shown as initial images in the content item.

The number of images in each set of the additional images may be predetermined (e.g., set by a content provider) or dynamically determined based on historical information, content provider information, or any combination thereof. For example, it may be determined that four additional images should be available for display upon detection of interest in the first image.

For example, the content item may be determined to show three images, and each of these three images may be determined to have an additional set of four more images that may be shown upon detection of interest. First, the three initial images that are selected for display in the content item may be determined based on any combination of factors including, but not limited to, historical information associated with the user or the user computing device (e.g., cookie information, user demographic information, user interests, etc.), content provider information including information selected by the content provider (e.g., a list of hot selling products), and historical interaction information with the images on other content devices. The additional set(s) of images may be determined based on any combination of factors including, but not limited to, historical information associated with the user or the user computing device (e.g., cookie information, user demographic information, user interests, etc.), content provider information including information selected by the content provider (e.g., a list of hot selling products), and historical interaction information with the images on other content devices. The initially shown images (e.g., the first image in FIG. 6) may be determined using the same or different factors from the factors used to determine the additional set(s) of images.

The sequential order of images in each set of additional images may be determined based on any combination of historical information associated with the computing device, content provider information including information selected by the content provider, and historical interaction information with the images on other content devices. For example, it may be determined that the four additional images for the first image slot are to be ordered in accordance with computations using one or more of the factors listed above. In some implementations, the order of additional images (or the additional images themselves) may be dynamically determined or changed based on interactions with the content item.

The first image and the plurality of additional images may be determined upon received a request for a content item for display on a device (e.g., client device 104). The request may include information associated with the client device 104 (e.g., cookie information, demographic information, interest information, etc.). The information received with the request for the content item may be utilized to determine the first image and the plurality of additional images.

The determined content item is provided (block 604) for display to the computing device. The client device may display the content item including the first image, and may then display the additional images, one image at a time, when interest is detected in the first image (e.g., by hovering their cursor over the image). The content item may have more than image slot and may show multiple images at the same time, with each image slot having a set of additional images. For example, as shown in FIG. 2, the content item 208 includes three image slots, and each image slot may display additional images upon detection of interest. In some implementations, the first image and the plurality of additional images are determined by the content service 122 upon receiving a request for a content item for the client device 104. The determined first image and the plurality of images are then provided for display to the client device 104.

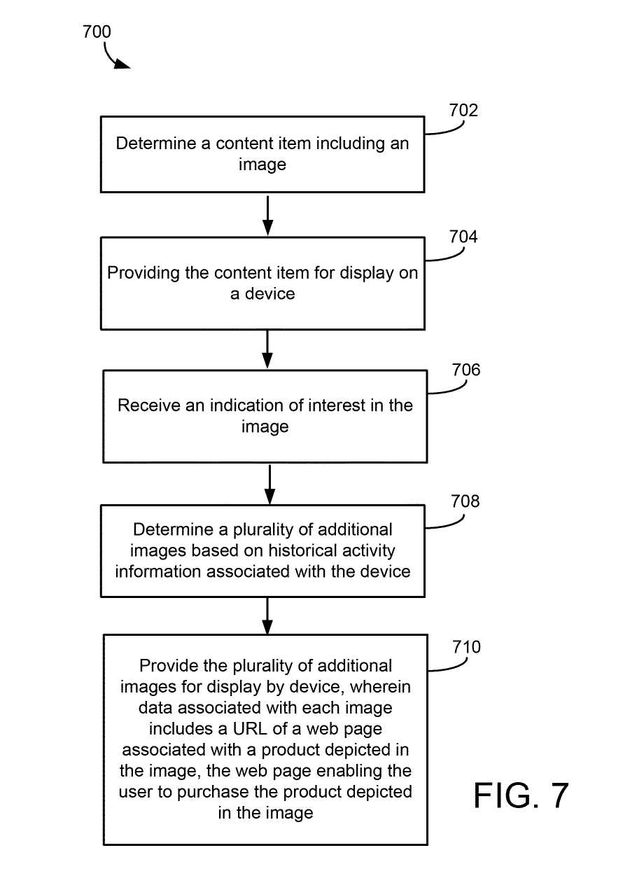

FIG. 7 is a flow diagram of a process 700 for determining a content item with dynamically selected images, in accordance with an illustrative implementation. The process 700 can be implemented on a computing device (e.g., the content service 122). In one implementation, the process 700 is encoded on a computer-readable medium that contains instructions that, when executed by the computing device, cause the computing device to perform operations of the process 700.

A content item including an image is determined (block 702). The content item may be determined by the content service 122. The content item may include a text portion, and/or one or more site links. The image may depict a product or a service. In one implementation, the content item may be an advertisement.

In one implementation, the image determined for the content item may be selected from a set of images pre-selected by the content provider for this content item or for this content item and another set of other content items. The image may be selected from the set of content provider pre-selected images based on historical information associated with the content device (e.g., historical interactions with other content items, demographic information, interest information, etc.).

In one implementation, the content provider may indicate their objectives for displaying content items on computing devices, and based on these objections, the image may be determined. The image may be determined based on any combination of information provided by the content provider including, but not limited to, images of top selling or popular products, product categories that are important to the content provider, products that are important to the content provider, etc.

In another implementation, the image may be determined based on historical interactions with images in content items previously displayed on other content devices. The historical interactions may include information regarding which images received the most interest, which images received the most conversions, etc.

In another implementation, the image may be determined based on information associated with the device on which the content item and the image will be displayed. For example, the image may be determined based on cookie information associated with the content device. When the content item is determined based on a provided search query, every image determined for the content item is associated with a set of keywords in the search query. As a result, the images with the closest keywords are included in the content item.

More than one image may be determined for the content item at block 702. The total number of images that are to be initially displayed in the content item may be pre-selected by the content provider. For example, the content provider may provide that four image slots are to be included in the content item.

The determined content item is provided (block 704) for display on a device. The client device may display the content item in a web page or in a device application. The content item may be displayed, and receive interactions.

An indication of interest in the image may be received (block 706). For example, interest in the image may be detected upon detection of cursor being placed over the image. In another example, interest in the image may be determined by detection of highlighting of the image, tapping on the image if the computing device has a touchscreen, etc.

A plurality of additional images based at least in part on historical activity information associated with the device is determined (block 708). In some implementations, the plurality of additional images may be determined based on any combination of historical activity information associated with the device (e.g., cookie information, interaction information on the computing device, interest information, demographic information, language information, information regarding activity on the computing device, etc.), content provider selected objectives for displaying content items on computing devices (e.g., images of top selling or popular products, product categories that are important to the content provider, products that are important to the content provider, etc.), information associated with historical interactions (e.g., information regarding which images received the most interest, which images received the most conversions, etc.) with images in content items previously displayed on other content devices, and other types of information.

In some implementations, the plurality of additional images are not determined in the same manner as the initial image. In one implementation, where the content provider has opted for his choice of images, the content provider can select the hot selling products in the order of decreasing demand. In another implementation, where the content provider indicated that the cache and cookies are to be used to determine the images, the images would be determined based on how recently products were viewed on the content provider webpages. Hence, the last viewed products on the content provider's webpage(s) would be picked up first for display in the content items.

The determined plurality of additional images may include the order in which the additional images are to be displayed in the content item. For example, the images in the plurality of additional images may be ordered based on objectives of the content provider, historical interactions information with these images on other content devices, historical information associated with the computing device, etc.

The additional images may be related (i.e., belong to the same product category) to the product shown in the image initially displayed. For example, the image determined in block 702 may be an image of shoes. In this example, the additional images may also depict products in the same product category (i.e., shoes) that are offered by the content provider. In another example, the plurality of additional images may include images of products from multiple product categories, some of which may be of the same product category as the initial image shown in the content item.

In one implementation, the plurality of additional images and the image determined in step 702 may be selected from a single set of images provided by the content provider. In another implementation, the image determined in step 702 may be selected from a first set of images provided by the content provider, while the plurality of additional images determined in step 708 may be selected from a second set of images provided by the content provider. For example, the first set of images may be a set of images that the content provider identified as images approved for initial display in the content item.

The plurality of additional images is provided for display by the device (block 710). These images may be shown, one image at a time, in the image slot in the content item initially displaying the image determined in block 702. In particular, upon detection of interaction with the image (i.e., the image determined in block 702) shown in the content item (e.g., by hovering of the initially shown image in the content item), the additional images are shown, one image at a time.

In other implementations, the additional images are of products unrelated to the product category of the product shown in the image determined in block 702. In these implementations, images of a variety of products offered by the content provider are displayed. The content provider may indicate whether they want additional images to show images of products of the same category.

Data associated with each image may include a URL of a web page associated with a product depicted in the image. The web page may be a billing webpage that allows for placing an order for the product depicted in the image. The web page may allow for selection of various product attributes including quantity, size, color, etc. FIG. 4 provides an exemplary webpage illustrating a billing webpage allowing for order placement.

The image determined in block 702 may be determined upon received a request for a content item for display on a device (e.g., client device 104). The request may include information associated with the client device 104 (e.g., cookie information, demographic information, interest information, etc.). The information received with the request for the content item may be utilized to determine the image and/or the plurality of additional images.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible.

The operations described in this specification can be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product embodied on a tangible medium or packaged into multiple such software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

What is claimed is:

1. A method comprising:
determining a content item including an image;
providing the content item for display on a device;
receiving an indication of interest in the image;
determining a plurality of additional images based on historical activity information associated with the device; and
providing the plurality of additional images for display by the device, in place of the image, wherein data associated with each image includes a URL of a web page associated with a product depicted in an image, the web page enabling the user to purchase the product depicted in the image.

2. The method of claim 1, wherein determining the image is based in part on a plurality of images selected by a content provider.

3. The method of claim 1, wherein the image depicts a product from a first product category.

4. The method of claim 3, wherein each image in the plurality of additional images depicts a product in the first product category.

5. The method of claim 1, further comprising receiving a user selection of an additional image from the plurality of additional images.

6. The method of claim 1, wherein the content item includes a text portion, and a link to a main webpage of a content provider.

7. A system comprising:
one or more data processors; and
one or more storage devices storing instructions that, when executed by the one or more data processors, cause the one or more data processors to perform operations comprising:
determining a content item including an image;
providing the content item for display on a device;
receiving an indication of interest in the image;
determining a plurality of additional images based on historical activity information associated with the device; and
providing the plurality of additional images for display by the device, in place of the image, wherein data associated with each image includes a URL of a web page associated with a product depicted in an image, the web page enabling the user to purchase the product depicted in the image.

8. The system of claim 7, wherein determining the image is based in part on a plurality of images selected by a content provider.

9. The system of claim 7, wherein the image depicts a product from a first product category.

10. The system of claim 9, wherein each image in the plurality of additional images depicts a product in the first product category.

11. The system of claim 7, the operations further comprising receiving a user selection of an additional image from the plurality of additional images.

12. The system of claim 7, wherein the content item includes a text portion, and a link to a main webpage of a content provider.

13. A computer-readable storage medium having instructions to provide information via a computer network, the instructions comprising instructions to:
determine a content item including an image;
provide the content item for display on a device;
receive an indication of interest in the image;
determine a plurality of additional images based on historical activity information associated with the device; and
provide the plurality of additional images for display by the device, in place of the image, wherein data associated with each image includes a URL of a web page associated with a product depicted in an image, the web page enabling the user to purchase the product depicted in the image.

14. The computer-readable storage medium of claim 13, wherein determining the image is based in part on a plurality of images selected by a content provider.

15. The computer-readable storage medium of claim 13, wherein the image depicts a product from a first product category.

16. The computer-readable storage medium of claim 15, wherein each image in the plurality of additional images depicts a product in the first product category.

17. The computer-readable storage medium of claim 13, further comprising receiving a user selection of an additional image from the plurality of additional images.

18. The computer-readable storage medium of claim 13, wherein the content item includes a text portion, and a link to a main webpage of a content provider.
